(19) United States
(12) Patent Application Publication
(10) Pub. No.: US 2007/0104382 A1
(43) Pub. Date: May 10, 2007

(54) Detection of local visual space-time details in a video signal

(75) Inventor: Radu Serban Jasinschi, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 10/579,930

(22) PCT Filed: Nov. 4, 2004
(86) PCT No.: PCT/IB04/03677

§ 371 Date: May 19, 2006

(30) Foreign Application Priority Data
Nov. 24, 2003 (EP) 03300223.9

(51) Int. Cl. G06K 9/40; G06K 9/36

(52) U.S. Cl. 382/254; 382/232

(57) ABSTRACT

The invention relates to video signal processing such as for TV or DVD signals. Methods and systems for detection and segmentation of local visual space-time details in video signals are described. Furthermore, a video signal encoder is described. The method described comprises the steps of dividing an image into blocks of pixels, calculating space-time feature(s) within each block, calculating statistical parameter(s) for each space-time feature(s), and detecting blocks wherein the statistical parameter(s) exceeds a predetermined level. Preferably, visual normal flow is used as a local space-time feature. In addition, visual normal acceleration may be used as space-time features. In preferred embodiments visual artefacts, such as blockiness, occurring by MPEG or H.26x encoding can be reduced by allocating a larger amount of bits to local image parts exhibiting a large amount of space-time details.

### FIELD OF THE INVENTION

The present invention relates to the field of video signal processing such as for TV or DVD signals. More specifically, the invention relates to methods for detection and segmentation of local visual space-time details in video signals. In addition, the invention relates to systems for detection and segmentation of local visual space-time details in video signals.

### BACKGROUND OF THE INVENTION

Data compression of video signal with a stream of images (frames) has become widespread since a large amount of channel or storage capacity can be saved in transmission of digital video data such as for TV or DVD. Specified standards such as MPEG and H.26x provide a high degree of data compression using block-based motion compensation techniques. Normally, macro-blocks of 16×16 pixels are used for representation of motion information. For many normal video signals these compression techniques provide a high data compression rate without suffering from any visual artefact that is perceptible by the human eye.

However, the standard compression schemes are known not to be transparent, i.e. for certain video signals they give rise to visual artefacts. Such visual artefacts occur in case the video signal includes motion pictures including local space-time details. Local space-time details are represented by spatial texture that varies its local characteristics in time in an indefinite manner. Examples are motion pictures of fire, wavy water, rising steam, leaves fluttering in the wind etc. In these cases the motion picture information representation by 16×16 pixel macro-blocks offered by the compression schemes is too coarse to avoid loss of visual information. This is a problem in relation to achieve optimal high quality video reproduction in combination with the benefits of MPEG or H.26x compression with respect to bit rate reduction.

In order to avoid visual artefacts in a video signal intended for compression, it is necessary to detect local space-time details that may cause visual artefacts by compression prior to applying the compression procedure. Having located these parts in the video signal it is possible to apply a special processing to these parts so as to avoid artefacts being introduced by the compression procedure. Methods for detecting and indicating image blocks of a video signal that include space-time details are known.

EP 0 571 121 B1 describes an image processing method being an elaboration of the known so-called Horn-Schunk method. This method is described in B. K. Horn, and B. G. Schunck, “Determining Optical Flow”, Artificial Intelligence, Vol. 17, 1981, pp. 185-204. The Horn-Schunk method includes extraction of pixel-wise image velocity information called optical flow. For each single image an optical flow vector is determined, and a condition number is computed based on this vector. In EP 0 571 121 B1 a local condition number is computed based on the optical flow vector for each image, the goal being to obtain a robust optical flow.

EP 1 233 373 A1 describes a method for segmentation of fragments of an image exhibiting similarities in various visual attributes. Various criteria are described for combining small regions of an image into larger regions exhibiting similar characteristics within a predetermined threshold. In relation to detection of motion an affine motion model is used which implies calculation of optical flow.

U.S. Pat. No. 6,456,731 B1 describes a method for estimation of optical flow and an image synthesis method. The described estimation of optical flow is based on the known Lucas-Kanade method described in B. D. Lucas, and T. Kanade, “An iterative image registration technique with an application to stereo vision”, Proceedings of the 7th International Joint Conference on Artificial Intelligence, 1981, Vancouver, pp. 674-679. The Lucas-Kanade method estimates optical flow by assuming that optical flow is constant within a local neighbourhood of a pixel. The image synthesis method is based on a process of registering consecutive images of a sequence by using values of estimated optical flow and a velocity of specifically tracked image points, visually salient like corner points, using the known so-called Tomasi-Kanade temporal feature tracking method. Thus, the method described in U.S. Pat. No. 5,456,731 B1 does not perform image partitioning, but similar to the method described in EP 0 571 121 B1, it performs the step of computing optical flow, and subsequently the step of image registering.

### SUMMARY OF THE INVENTION

It may be seen as an object of the present invention to provide a method of detecting local space-time details in a video signal. The method must be simple to implement and it must be adapted for application within low cost equipment. By space-time details of an image is understood image regions containing a large spatial brightness variation that exhibits strong temporal changes at the local level, wherein a velocity of these spatial parts are weakly correlated in time.

A first aspect of the present invention provides a method of detecting local space-time details of a video signal representing a plurality of images, the method comprising, for each image, the steps of:
A) dividing the image into one or more blocks of pixels,
B) calculating at least one space-time feature for at least one pixel within each of said one or more blocks,
C) calculating for each of the one or more blocks at least one statistical parameter for each of the at least one space-time features calculated within the block, and
D) detecting blocks wherein the at least one statistical parameter exceeds a predetermined level.

Preferably, the at least one space-time feature comprises visual normal flow magnitude and/or visual normal flow direction. The visual normal flow represents the component of the optical flow that is parallel to image brightness spatial gradient. The at least one space-time feature may further comprise visual normal acceleration magnitude and/or visual normal acceleration direction. Visual normal acceleration describes temporal variation of the visual normal flow along the normal (image brightness gradient) direction.

Preferably, the method further comprises the steps of calculating horizontal and vertical histograms of the at least one space-time feature calculated in step C).

The at least one statistical parameter of step D) may comprise one or more of: variance, average, and at least one parameter of a probability function. The block(s) of pixels are preferably non-overlapping square blocks, and their size may be: 2×2 pixels, 4×4 pixels, 6×6 pixels, 8×8 pixels, 12×12 pixels, or 16×16 pixels.

The method may further comprise the step of pre-processing the image prior to applying step A), so as to reduce noise in the image, this pre-processing preferably comprising the step of convolving the image with a low-pass filter.

The method may further comprise an intermediate step between step C) and D), the intermediate step comprising calculating at least one inter-block statistical parameter involving at least one of the statistical parameter calculated for each block. The at least one inter-block statistical parameter may be calculated using a 2-D Markovian non-causal neighbourhood structure.

The method may further comprise the step of determining a pattern of temporal evolution for each of the at least one statistical parameter calculated in step C). The method may further comprise the step of indexing at least part of an image comprising one or more blocks detected in step D). Furthermore, the method may comprise the step of increasing data rate allocation to the one or more blocks detected in step D). In another embodiment, the method may further comprise the step of inserting an image in a de-interlacing system.

A second aspect of the invention provides a system for detecting local space-time details of a video signal representing a plurality of images, the system comprising:
means for dividing an image into one or more blocks of pixels,
space-time feature calculating means for calculating at least one space-time feature for at least one pixel within each of the one or more blocks,
statistical parameter calculating means for calculating for each of the one or more blocks at least one statistical parameter for each of the at least one space-time features computed within the one or more blocks, and
detecting means for detecting one or more blocks wherein the at least one statistical parameter exceeds a predetermined level.

A third aspect of the invention provides a device comprising a system according to the system of the second aspect.

A fourth aspect of the invention provides a signal processor system programmed to operate according to the method of the first aspect.

A fifth aspect of the invention provides a de-interlacing system for a television (TV) apparatus, the de-interlacing system operating according to the method of the first aspect.

A sixth aspect provides a video signal encoder for encoding a video signal representing a plurality of images, the video signal encoder comprising:
means for dividing an image into one or more blocks of pixels,
space-time feature calculating means for calculating at least one space-time feature for at least one pixel within each of the one or more blocks,
statistical parameter calculating means for calculating for each of the one or more blocks at least one statistical parameter for each of the at least one space-time features computed within the one or more blocks,
means for allocating data to the one or more blocks according to a quantisation scale, and
means for adjusting the quantisation scale for the one or more blocks in accordance with the at least one statistical parameter.

A seventh aspect provides a video signal representing a plurality of images, the video signal comprising information regarding image segments exhibiting space-time details suitable for use with the method of the first aspect.

An eighth aspect provides a video storage medium comprising video signal data according to the seventh aspect.

A ninth aspect provides a computer useable medium having a computer readable program code embodied therein, the computer readable program code comprising:
means for causing a computer to read a video signal representing a plurality of images,
means for causing the computer to divide a read image into one or more blocks of pixels,
means for causing the computer to calculate at least one space-time feature for at least one pixel within each block,
means for causing the computer to calculate for each of the blocks at least one statistical parameter for each of the at least one space-time features calculated within the one or more blocks, and
means for causing the computer to detect blocks wherein the at least one statistical parameter exceeds a predetermined level.

A tenth aspect provides a video signal representing a plurality of images, the video signal being compressed according to a video compression standard, such as MPEG or H.26x, comprising a specified individual allocation of data to blocks of each image, wherein a data rate allocated to one or more selected blocks of images exhibiting space-time details is increased compared to the specified allocation of data to the one or more selected blocks.

An eleventh aspect provides a method of processing a video signal, wherein the method of processing comprises the method of the first aspect.

A twelfth aspect provides an integrated circuit comprising means for processing a video signal according to the method of the first aspect.

A thirteenth aspect provides a program storage device readable by a machine and encoding a program of instructions for executing the method of the first aspect.

### BRIEF DESCRIPTION OF DRAWINGS

In the following the invention is described in details with reference to the accompanying figures, wherein

FIG. 1 shows an illustration of normal and tangential flows at two points of a contour moving with uniform velocity,

FIG. 2a shows an example of an image of two persons and a fountain basin including splashing water,

FIG. 2b shows a grey scale plot representing for the image of FIG. 2a a block-wise level of normal flow variance, wherein white blocks indicate blocks calculated to have a high level of normal flow variance,

FIG. 3 shows a flow diagram of a system according to the present invention, and

FIG. 4 shows an example of a normal flow variance histogram.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the scope of the invention as defined by the appended claims.

### DETAILED DESCRIPTION OF THE INVENTION

According to an embodiment of the present invention the major operations to be carried out for processing an image are the steps:

A) Divide image into blocks

B) Estimate local feature(s)

C) Calculate feature statistics per block

Step A) of processing an image is to divide the image into blocks. Preferably, the blocks coincide with macro blocks used by standard compression such as MPEG and H.26x. Therefore, the image is preferably divided into non-overlapping blocks of 8×8 pixels or 16×16 pixels. The image blocks, when 8×8 pixels large and when they are aligned with the (MPEG) image grid, coincide with typical I-frame DCT/IDCT computation and describe spatial details information. When 16×16 pixels large and when they are aligned with the (MPEG) image grid, coincide with P-frame (B-frame) macro blocks for doing motion compensation (MC) in block-based motion estimation in MPEG/H.26x video standards, and this allows to describe spatio-temporal details information.

Step B) comprises estimating at least one local feature, the local feature relating to spatial, temporal, and/or spatio-temporal details of the image. Preferably, two features are used together with different associated metrics. The estimation of local features is based on a combination of spatial and temporal image brightness gradients. The preferred features are visual normal flow, i.e. and visual normal velocity and visual normal acceleration. The local feature may be based on either or both of visual normal velocity and visual normal acceleration. For the case of visual normal velocity two consecutive frames (or images) are used, while for the visual normal acceleration three consecutive frames (or images) are necessary. A more thorough description of visual normal velocity and visual normal acceleration is given in the following.

Step C) comprises calculating a per block feature statistics. This includes the computation of feature average and variance. Also, different probability density functions are matched to this per block statistics. The per block statistics provides information so as to set up thresholds or criteria allowing a categorisation of each block with respect to the amount of space-time details. Thus, the per block statistics allows detection of blocks with a high amount of space-time details, since such blocks exhibit per blocks statistical parameters exceeding predetermined thresholds.

The visual normal flow represents the component of the optical flow that is parallel to image brightness spatial gradient. Optical flow is the most detailed velocity information that can be extracted locally by processing two successive frames or video fields, but it is computationally expensive to extract. The normal flow, on the other side, is easy to compute and it is very rich in local spatial and temporal information. For example calculation of optical flow requires typically 7×7×2 space-time neighbourhoods, while normal flow requires only 2×2×2 neighbourhoods. In addition, calculation of optical flow requires an optimisation, while calculation of normal flow does not.

The normal flow magnitude determines the amount of motion parallel to the local image brightness gradient and the normal flow direction describes the local image brightness orientation. Visual normal flow is calculated from:

$${v}_{x} \times \frac{\partial I ( x , y , t )}{\partial x} + {v}_{y} \times \frac{\partial I ( x , y , t )}{\partial y} + \frac{\partial I ( x , y , t )}{\partial t} = 0 ,$$

where I is brightness, x and y are spatial variables, and t is the time variable. The normal flow direction encodes implicitly spatial variation of image brightness gradient and therefore spatial texture information. The normal acceleration describes, as a second order effect, how the normal flow varies locally.

Visual normal flow is defined as the normal, i.e. parallel to the spatial image gradient, component of the local image velocity or optical flow. The image velocity can be decomposed, at each image pixel, into normal and tangential components.

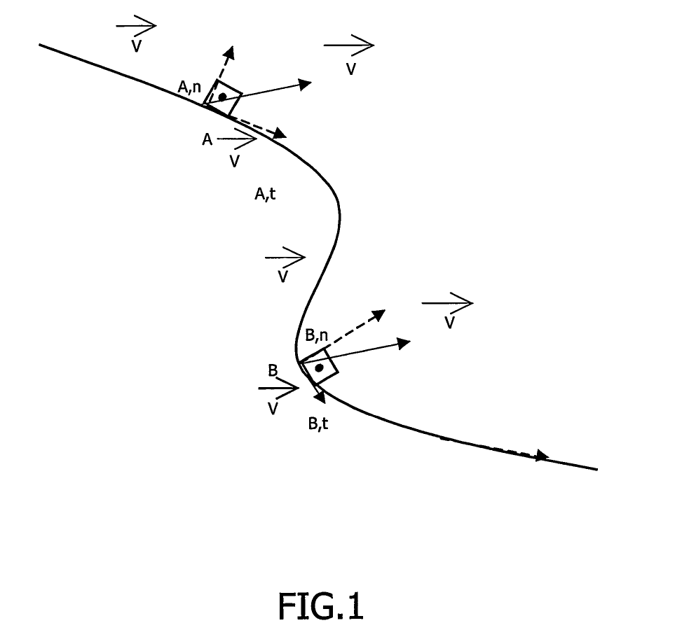

FIG. 1 shows, for illustration, a well-defined image boundary or contour that passes the target pixel of an image. The diagram in FIG. 1 shows the normal and tangential flows at two points of a contour moving with uniform velocity \vec{V}. Going from point A to point B, the normal and tangential image velocities (normal flow and tangential flow, respectively) change their spatial orientation. This indeed happens from point to point due to contour curvature. The normal and tangential flows are always 90° apart.

An important property of the normal flow is that this in the only image velocity component that can be locally computed in the image. The tangential component can not be computed. In order to explain this, it can be assumed that the image brightness I() is constant when image point P(x,y) at time t moves to position P′(x′,y′) at time Δt t′=t+Δt, were (x′,y′)=(x,y)+\vec{V}·Δt. The image velocity is considered to be constant and Δt is “small”. Therefore,

$$\begin{matrix}I ( {x}^{′} , {y}^{′} , {t}^{′} ) \approx I ( x , y , t ) \\ or & ( 1 ) \\ \vec{V} \cdot \vec{∇} I ( x , y , t ) + \frac{\partial I ( x , y , t )}{\partial t} \approx 0 & ( 2 )\end{matrix}$$

were ‘≈’ means approximate and ∇≡(∂/∂x, ∂/∂y). Since \vec{V}=\vec{V}ₙ+\vec{V}ₜ and \vec{V}ₜ·\vec{∇}=0, (2) reduces to:

$${\vec{V}}_{n} \cdot \vec{∇} I ( x , y , t ) + \frac{\partial I ( x , y , t )}{\partial t} \approx 0. \qquad ( 3 )$$

This means that:

$$\begin{matrix}{\vec{V}}_{n} = \hat{n} \vert {\vec{V}}_{n} \vert , \\ with & ( 4 ) \\ \vert {\vec{V}}_{n} \vert = \frac{\vert \frac{\partial I ( x , y , t )}{\partial t} \vert}{\vert ∇ I ( x , y , t ) \vert} & ( 5 ) \\ \hat{n} ≡ \frac{\vec{∇} I ( \cdot , \cdot ; \cdot )}{\vert \vec{∇} I ( \cdot , \cdot ; \cdot ) \vert} . & ( 6 )\end{matrix}$$

The normal flow, in distinction to the image velocity, is also a measure of local image brightness gradient orientation, and this measures implicitly includes the amount of spatial shape variability, e.g. curvature, texture orientation, etc.

Preferably, two different methods may be used to compute the normal flow in discrete images I[i][j][k]. One method is the 2×2×2 brightness cube method is described in B. K. P. Horn, Robot Vision, The MIT Press, Cambridge, Mass., 1986. Another method is the feature based method.

In the 2×2×2 brightness cube method the spatial and temporal derivatives are approximated according to (7)-(9).
∂I(x,y;t)/∂x≈¼×[(I[i+1][j][k]+I[i+1][j][k+1]+I[i+1][j+1][k]+I[i+1][j+1][k+1])−(I[i][j][k]+I[i][j][k+1]+I[i][j+1][k]+I[i][j+1][k+1])]. (7)
∂I(x,y;t)/∂y≈¼×[(I[i][[j+1][k]+I[i][j+1][k+1]+I[i+1][j+1[k]+I[i+1][j+1][k+1])−(I[i][j][k]+I[i][j][k+1]+I[i+1][j][k]+I[i+1][j][k+1])] (8)
∂I(x,y;t)/∂t≈¼×[(I[i][[j][k+1]+I[i][j+1][k+1]+I[i+1][j][k+1]+I[i+1][j+1][k+1])−(I[i][j][k]+I[i][j]+1][k]+I[i+1][j][k]+I[i+1][j+1][k])] (9)

These discrete derivatives are computed inside the cells of a 2×2×2 brightness cube.

The feature based method is based on the following steps:
(a) Finding image points with high spatial gradients. This is implemented by: (i) smoothing the image I() by applying to it a binomial approximation to a Gaussian function;, (ii) computing the discretised spatial image gradients
   ∂Ĩ/∂x≈½·(I[i+1][j][k]−I[i−1][j][k]) and
   ∂Ĩ/∂y≈½·(I[i][j+1][k]−I[i][j−1][k]); (iii) finding the subset of image points for which |∇I()| is larger than a pre-determined threshold T_{Gr}. Also, use
   ∂Ĩ/∂t≈½·(I[i][j][k+1]−I[i][j][k−1]), which involves three instead of two successive frames.
(b) The normal flow is computed interactively at each feature position, e.g. point with “high” spatial gradient, by using the discrete version of (5) and (6). First, with the initial computation of the normal flow, the local image is warped according to it to refine the normal flow value. From the residual temporal derivative the residual normal flow is computed and the initial normal flow estimate is updated. This is repeated until the residual normal flow is smaller than ε (e.g. 0001).

Normal acceleration describes temporal variation of the normal flow along the normal (image brightness gradient) direction. Its importance is due to the fact that the acceleration measures how much the normal flow varies between, at least three successive frames, and thus making it enables to determine how much the space-time details vary between pairs of frames.

One way to define the normal acceleration is by taking the temporal derivative of (3):

$$\frac{\partial }{\partial t} [ {\vec{V}}_{n} \cdot \vec{∇} I ( x , y , t ) + \frac{\partial I ( x , y , t )}{\partial t} ] = {\vec{A}}_{n} \cdot \vec{∇} I ( x , y , t ) + {\vec{V}}_{n} \cdot \frac{\partial }{\partial t} \vec{∇} I ( x , y , t ) + \frac{{\partial }^{2} I ( x , y , t )}{{\partial }^{2} t} \approx 0 \qquad ( 10 )$$

so that:

$$\begin{matrix}{\vec{A}}_{n} = \hat{n} \vert {\vec{A}}_{n} \vert , \\ and & ( 11 ) \\ \vert {\vec{A}}_{n} \vert = \frac{\vert \vec{∇} I ( x , y , t ) \vert \cdot \frac{{\partial }^{2} I ( x , y , t )}{{\partial }^{2} t} + \vert \frac{\partial I ( x , y , t )}{\partial t} \vert \cdot \vert \frac{\partial \vec{∇} I ( x , y , t )}{\partial t} \vert}{{\vert ∇ I ( x , y , t ) \vert}^{2}} . & ( 12 )\end{matrix}$$

Because of the second temporal derivative in (12), it is necessary to use a minimum of three successive frames when implementing (12). Taking a 3×3×3 pixels wide cube to compute the discretised versions of the derivatives in (12); it can be shown that:

$$\frac{{\partial }^{2} I}{{\partial }^{2} t} \approx \frac{1}{6} [ I [ j + 1 ] [ k - 1 ] + 2 \cdot I [ i ] [ j ] [ k - 1 ] + I [ i ] [ j - 1 ] [ k - 1 ] + I [ i + 1 ] [ j ] [ k - 1 ] + I [ i - 1 ] [ j ] [ k - 1 ] - 2 \cdot ( I [ i ] [ j + 1 ] [ k ] + 2 \cdot I [ i ] [ j ] [ k ] + I [ i ] [ j - 1 ] [ k ] + I [ i + 1 ] [ j ] [ k ] + I [ i - 1 ] [ j ] [ k ] ) + I [ i ] [ j + 1 ] [ k + 1 ] + 2 \cdot I [ i ] [ j ] [ k + 1 ] + I [ i ] [ j - 1 ] [ k + 1 ] + I [ i + 1 ] [ j ] [ k + 1 ] + I [ i - 1 ] [ j ] [ k + 1 ] ] ; \qquad ( 13 )$$

The other discretised derivatives can be obtained to (7)-(9) on the 3×3×3 cube.

The goal of computing feature statistics is to detect space-time regions were a given feature varies most—the segmentation and detection of high space-time details. This may be implemented according to the following algorithm, given two (three) successive images:
1. Dividing the image into non-overlapping (square or rectangular) blocks,
2. Computing within each block a local feature set,
3. Determining, for each block, the average of the feature set computed in 2., and
4. Computing the variance, average variation of each feature within each block from the variance computed in 3.,
5. Given a thresholdTₛₜₐₜ, selecting a set of blocks for which the variance computed in 4. is larger than Tₛₜₐₜ.

In our implementation of the algorithm we choose square (8×8 or 16×16) blocks. This will tessellate the image into square blocks, and the remainder of it will be left untessellated; in order to reduce this residual untessellated image region a rectangular tessellation could be used, but this is not so interesting because we want to align these blocks with MPEG 8×8 (DCT) or 16×16 (MC) blocks for visual artefact pre-detection. The computation of feature values within each block is implemented either at each pixel, for which |∇I()| is larger than a pre-determined threshold T, or at feature points for which |∇I()| is larger than a pre-determined threshold T_{Gr}; usually T<T_{Gr}. The statistics exemplified in steps 4. and 5. are just an illustration. More detailed statistics could be computed. Also, specific probability distribution densities (pdf) and their statistics could be computed.

In order to make the computations according to the above-mentioned or related implementations more robust, a set of pre- and post-processing operations may be applied. An example of pre-processing is to convolve the input images with low-pass filters. Post-processing may include, for example, comparing neighbour blocks with respect to their statistics, e.g. feature variance.

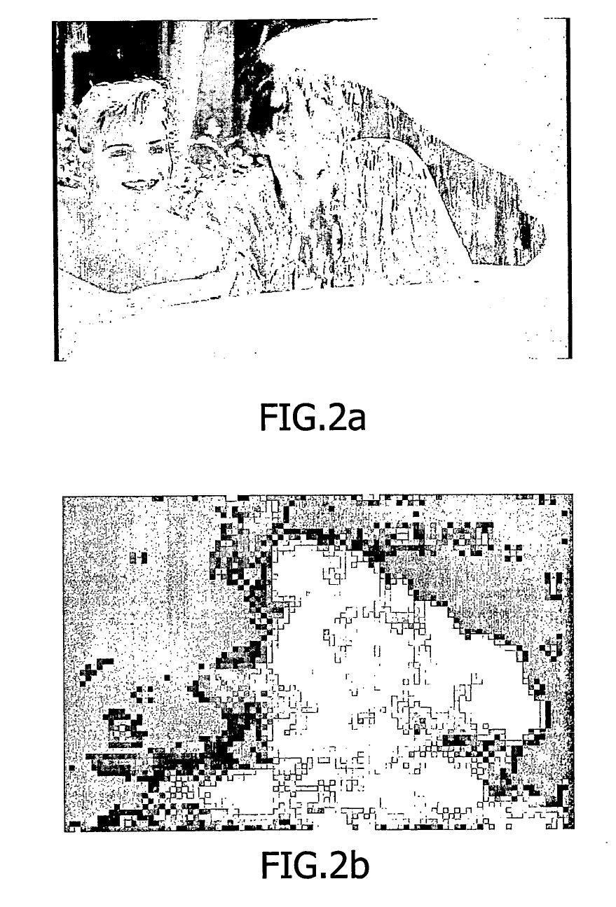

FIG. 2a shows an example of an image taken from a sequence of images. In the image two persons are watching splashing water in a fountain basin. One of the persons is partly behind the splashing water. Such an image therefore includes local parts exhibiting an example of a phenomenon expected to produce a chaotic brightness pattern, namely the splashing water. Therefore, the image is taken from a moving image sequence with the potential of a high amount of local space-time details. The image has been processed according to the present invention in blocks, and for each block a variance of normal flow magnitude has been calculated as a measure representing the amount of space-time details.

In FIG. 2b the blocks of the image of FIG. 2a are shown in a grey scale indicating normal flow magnitude variance and thereby indicates the amount of local space-time details. White coloured blocks indicate regions with a high level of normal flow variance, whereas dark grey blocks indicate regions with a low level of normal flow variance. As seen from FIG. 2b white blocks appear in parts of the image with splashing water and thus these local image regions are found to exhibit a large amount of local space-time details according to the processing method. The steady image regions, such as the person to the left and the fountain basin to the right, are seen to be dark grey, indicating that these regions are detected to exhibit a low normal flow variance.

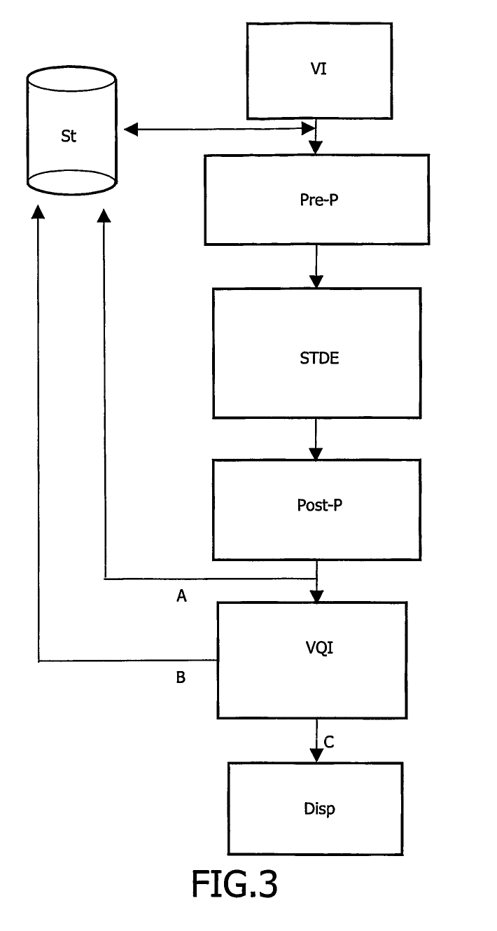

FIG. 3 show a flow diagram structure of a system for processing space-time details information. The system sketched in FIG. 3 can be used for different applications by using different of paths A, B and C indicated in the flow diagram. The elements of FIG. 3 are:
VI: Video Input
Pre-P: Pre-processing
STDE: Space-time detail estimation and detection
Post-P: Post-processing
VQI: Visual quality improvement
Disp: Display
St: Storage medium

Video input of FIG. 3 represents a video signal representing a sequence of images. The video input may either be applied directly, such as by a wire or wireless, or as indicated in FIG. 3, the video signal may be stored on a storage medium before being processed. The storage medium may be a hard disk, a writeable CD, a DVD, computer memory etc. Input may either be a compressed video format, such as MPEG or H.26x, or it may be a non-compressed signal, i.e. a full resolution representation of the video signal. If an analog video signal is input, the VI step may include an analog to digital conversion.

Pre-processing of FIG. 3 is optional. If preferred, various signal processing may be applied in order to reduce noise or other visual artefacts in the video signal before applying the space-time detection processing. This enhances the effect of the space-time detection processing.

Space-time detail estimation and detection (STDE) is performed according to the above-described methods. Preferably the method includes calculation of visual normal flow and it may further include calculation of visual normal acceleration. The necessary calculation means may be a dedicated video signal processors. Alternatively, since the amount of calculations needed with the methods according to the present invention signal processing may be implemented using signal processing power already present in the device, such as a TV set or a DVD player.

Post-processing may include various per block statistical methods performed on statistical results for each of the blocks of the STDE part of the system of FIG. 3. The post-processing may further include an integration in time of the statistical results for each of the blocks of the STDE step of FIG. 3. In addition, the post-processing may comprise determining a pattern of temporal evolution of the per block statistics in time. This is necessary to determine which parts have a stable statistics.

Using path A of FIG. 3 the video signal is stored after detection of space-time details. Preferably, the video signal is stored together with indexing information allowing further processing to be performed later.

Alternatively, visual quality improvement means may be applied before storing, i.e. path B may be used. Visual quality improvement means may be provided to the signal so as to utilise the provided information regarding local regions of images containing a large amount of space-time details. For a non-compressed video signal this may be done by allocating, to blocks with space-time details, a larger data rate than would normally be allocated by standard coding schemes—for example by reducing the quantisation scale in I-frame and P-frame coding, to cope with higher levels of details. The signal may then be stored in an encoded version, however processed so as to eliminate or avoid visual artefacts. The video signal may be store without encoding but provided with indexing information indicating blocks or regions with space-time details thus enabling further processing such as later encoding or using the space-time index information as a search criterion.

The last processing part of the system of FIG. 3 is a visual output, i.e. display, such as on a TV screen, a computer screen etc. Alternatively, the video signal may be applied to further devices or processors before being displayed or stored.

An application (i) of the principles according to the present invention is to eliminate or at least reduce visual artefacts in a video signal, such as the artefact blockiness or temporal flickering, by allocating more bits for blocks detected to exhibit space-time details. In some situations it may be preferred merely to obtain an indication of images/video regions which will contain probable visual artefacts, such as, blockiness, ringing, and mosquito “noise” for digitally (MPEG, H.26x) processed videos once encoded.

Another application (ii) is to implement a low cost motion detection indicator for field insertion in de-interlacing for TV systems that can profit from a spatial sharpness improvement. This may be especially suitable for application within low cost de-interlacers, the principles according to the invention providing a partial motion compensation information.

Yet another application (iii) is to detect, segment, index and retrieve image regions detected to exhibit space-time details in long video databases. In this way it may be possible to provide a search facility that allows a quick indexing of sequences of e.g. video films that contain waterfalls, ocean waves, hair/leaves/grass moving in the wind etc. Depending on which application is targeted, different processing blocks are used.

Yet, another possible application (iv) is to perform selective sharpening, i.e. to adaptively change the spatial sharpness (peaking and clipping) to highlight selected regions of an image where a sharper image is desired, and to reduce the possibility of increasing the visibility of digital artefacts in regions that are de-selected.

For example, application (i) can be used in both visual quality improvements for display and storage applications. For display application path C in FIG. 5 is used. Display applications may be such as high quality TV sets. Detection and segmentation of space-time details is important due to the fact that visual artefacts can be eliminated or at least reduced by an appropriate allocation of bits in response to local/regional image characteristics, such as, a customised bit-rate control per 8×8 or 16×16 image blocks. This is important relating to visual artefacts because often by just detecting may be too late to reduce their visibility or effects on the visual quality of motion pictures when displayed.

In storage applications path A or path B of FIG. 5 may be used. By using path A the video signal is stored prior to performing visual quality improvement. However, using path A may include detection and segmentation of space-time details and storage of indexing of regions, such as 8×8 or 16×16 pixel blocks, that contain a large amount of space-time details. In this way a long video databases (stored content) may be processed enabling a further process at a later stage. This is useful for content information that is highly detailed and for which no effective representation is known for content description. Video signals may be stored either compressed or uncompressed. By storing uncompressed data a later compression can be performed taking advantage of the stored index relating to local space-time details.

By using path B video signals are stored after being properly processed with respect to increasing visual quality based on the detected local space-time details. As mentioned, the visual quality improvement could be performed by allocating more data to blocks exhibiting a space-time details. Therefore, path B may also be used for processing large video databases. Using path B video signals can be stored compressed since a proper signal treatment has been carried out ensuring that a high visual quality regarding space-time details is obtained even by use of compression.

Among a large amount of different devices or systems, parts of devices or systems, the principles according to the invention may be applied within TV systems, such as TV sets, and DVD+RW equipment, such as DVD players or DVD recorders. The proposed methods may be applied within digital (LCD, LCoS) TV sets where new types of digital artefacts occur and/or become more visible and thus requiring a generally high video signal quality.

The principles of the present invention relating to visual quality improvement may be used also within wireless hand-held miniature devices featuring displays adapted for showing motion pictures. For example, a high visual quality of motion pictures on mobile phones with near to the eye displays can be combined with still a moderate data rate requirement. For devices with a quite poor spatial resolution the visual quality improvements according to the invention may be used to reduce the required data rate for the video signal, and still without blockiness and related visual artefacts.

In addition, the principles according to the invention may be applied within MPEG coding and decoding equipment. The methods may be applied within such encoders or decoders. Alternatively, separate video processor devices may be applied prior to existing encoders. The principles according to the invention may be applied within consumer equipment as well as within professional equipment.

In an embodiment of a video signal encoder according to the invention, a quantisation scale at the encoder side depending on space-time details information is applied. The quantisation scale is modulated by space-time details information. The smaller (larger) this scale the more (less) steps the quantizer has, and therefore more (less) spatial details is enhanced (blurred). Preferably, a video signal encoder according to the invention is capable of producing signal formats in accordance with MPEG or H.26x formats.

In a preferred embodiment, a fixed quantisation scale per macroblock q_sc is used. A modulation is applied to q_sc, wherein the modulation using information about space-time details. For each macroblock the normal flow (per pixel) and its average and variance σᵥ_{ₙ} (per macroblock) are calculated. From experiments it is known that the normal flow variance has a histogram for which the Gamma (Erlang) function is a good fit. With this knowledge, it is possible to fit:
M(x)=x×exp(−(x−1))
(shifted Gamma (Erlang) function) to the histogram of σᵥ_{ₙ}. With this, the quantisation scale per macroblock becomes:
q_{—}sc_{—}m=F(δ×q_{—}sc−λ×M(σ _{v̅}_{ₙ})),
where F( ) represents the operations of rounding and table look-up, and δ and λ are real numbers (positive for δ and positive and negative for λ) that are adjusted according to an overall amount of bits preferred to assign per frame (video sequence).

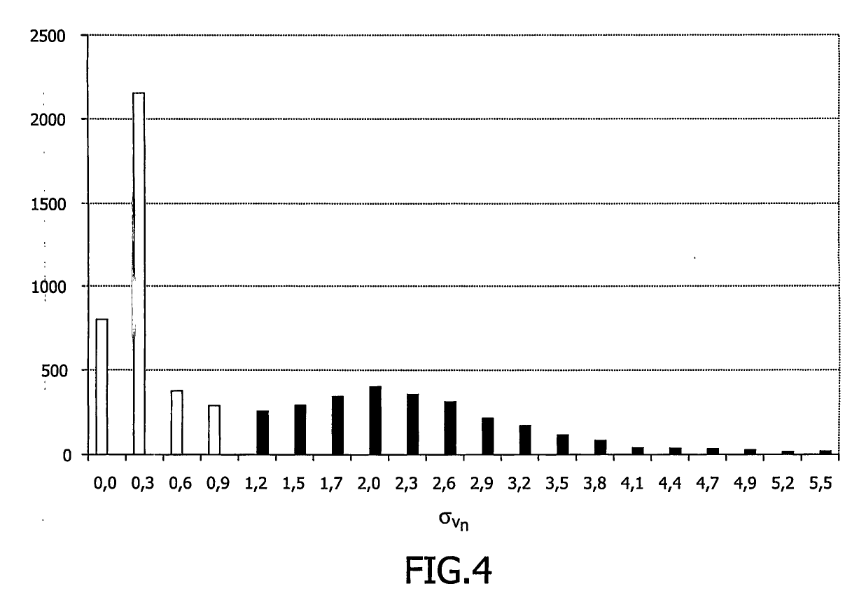

FIG. 4 shows an example of a histogram plotted for a sequence exhibiting image parts with a high amount of space-time details. The sequence processed is the sequence of a girl running in the foreground, while part of the background is the sea with water waves hitting rocks. The histogram of FIG. 4 shows a number of blocks as a function of normal flow variance. The white bars indicate flat areas, i.e. areas with a small amount of space-time details, e.g. the sky. The black bars indicate areas with a high amount of space-time details, e.g. water waves hitting the rocks. As seen from the histogram there is a good correlation between space-time details and normal flow variance, since bars representing areas with small amount of space-time details are grouped towards low normal flow variance values, while bars representing high amount of space-time details are grouped towards high normal flow variance values.

In the foregoing, and also with regard to the accompanying claims, it will be appreciated that expressions such as “incorporate”, “contain”, “include”, “comprise”, “is” and “have” are intended to be construed non-exclusively, namely other parts or components are potentially present which have not been explicitly specified.

1. A method of detecting local space-time details of a video signal representing a plurality of images, the method comprising, for each image, the steps of:
A) dividing the image into one or more blocks of pixels,
B) calculating at least one space-time feature for at least one pixel within each of said one or more blocks,
C) calculating for each of the one or more blocks at least one statistical parameter for each of the at least one space-time features calculated within the block, and
D) detecting blocks wherein the at least one statistical parameter exceeds a predetermined level.

2. A method according to claim 1, wherein the at least one space-time feature is selected from a group consisting of: visual normal flow magnitude, visual normal flow direction.

3. A method according to claim 1, wherein the at least one space-time feature is selected from a group consisting of: visual normal acceleration magnitude, and visual normal acceleration direction.

4. A method according to claim 1, wherein the at least one statistical parameter of step D) is selected from a group consisting of: variance, average, and at least one parameter of a probability function.

5. A method according to claim 1, wherein the one or more blocks of pixels are one or more non-overlapping square blocks, and wherein a size of the one or more square blocks is selected from a group consisting of: 2×2 pixels, 4×4 pixels, 6×6 pixels, 8×8 pixels, 12×12 pixels, and 16×16 pixels.

6. A method according to claim 1, further comprising the step of pre-processing the image prior to applying step A), so as to reduce noise in the image.

7. A method according to claim 6, wherein the step of pre-processing comprises convolving the image with a low-pass filter.

8. A method according to claim 1, further comprising an intermediate step between step C) and D), wherein the intermediate step comprises calculating at least one inter-block statistical parameter involving at least one of the statistical parameter calculated for each block.

9. A method according to claim 8, wherein the at least one inter-block statistical parameter is calculated using a 2-D Markovian non-causal neighbourhood structure.

10. A method according to claim 1, further comprising the step of determining a pattern of temporal evolution for each of the at least one statistical parameter calculated in step C).

11. A method according to claim 1, further comprising the step of indexing at least part of an image comprising one or more blocks detected in step D).

12. A method according to claim 1, further comprising the steps of calculating horizontal and vertical histograms of the at least one space-time feature calculated in step C).

13. A method according to claim 1, further comprising the step of increasing data rate allocation to the one or more blocks detected in step D).

14. A method according to claim 1, further comprising the step of inserting an image in a de-interlacing system.

15. A system for detecting local space-time details of a video signal representing a plurality of images, the system comprising:
means for dividing an image into one or more blocks of pixels,
space-time feature calculating means for calculating at least one space-time feature for at least one pixel within each of the one or more blocks,
statistical parameter calculating means for calculating for each of the one or more blocks at least one statistical parameter for each of the at least one space-time features computed within the one or more blocks, and
detecting means for detecting one-or-more blocks wherein the at least one statistical parameter exceeds a predetermined level.

16. A device comprising a system according to claim 15.

17. A signal processor system programmed to operate according to the method of claim 1.

18. A de-interlacing system for a television (TV) apparatus, the de-interlacing system operating according to the method of claim 1.

19. A video signal encoder for encoding a video signal representing a plurality of images, the video signal encoder comprising:
means for dividing an image into one or more blocks of pixels,
space-time feature calculating means for calculating at least one space-time feature for at least one pixel within each of the one or more blocks,
statistical parameter calculating means for calculating for each of the one or more blocks at least one statistical parameter for each of the at least one space-time features computed within the one or more blocks,
means for allocating data to the one or more blocks according to a quantisation scale, and
means for adjusting the quantisation scale for the one or more blocks in accordance with the at least one statistical parameter.

20. A video signal representing a plurality of images, the video signal comprising information regarding image segments exhibiting space-time details suitable for use with the method of claim 1.

21. A video storage medium comprising video signal data according to claim 20.

22. A computer useable medium having a computer readable program code embodied therein, the computer readable program code comprising:
means for causing a computer to read a video signal representing a plurality of images,
means for causing the computer to divide a read image into one or more blocks of pixels,
means for causing the computer to calculate at least one space-time feature for at least one pixel within each block,
means for causing the computer to calculate for each of the blocks at least one statistical parameter for each of the at least one space-time features calculated within the one or more blocks, and
means for causing the computer to detect blocks wherein the at least one statistical parameter exceeds a predetermined level.

23. A video signal representing a plurality of images, the video signal being compressed according to a video compression standard, such as MPEG or H.26x, comprising a specified individual allocation of data to blocks of each image, wherein a data rate allocated to one or more selected blocks of images exhibiting space-time details is increased compared to the specified allocation of data to the one or more selected blocks.

24. A method of processing a video signal, wherein the method of processing comprises the method of claim 1.

25. An integrated circuit comprising means for processing a video signal according to the method of claim 1.

26. A program storage device readable by a machine and encoding a program of instructions for executing the method of claim 1.
